(19) United States
(12) Patent Application Publication
(10) Pub. No.: US 2026/0057542 A1
(43) Pub. Date: Feb. 26, 2026

(54) SHADOW GUIDED HAND SCALE AND DISTANCE ESTIMATION

(71) Applicant: Snap Inc., Santa Monica, CA (US)

(72) Inventors: Georgios Evangelidis, Vienna (AT); Vsevolod Konjahhin, Vienna (AT); Simon Schreiberhuber, Vienna (AT); Dmytro Siryk, Vienna (AT); Kai Zhou, Wiener Neudorf (AT)

(21) Appl. No.: 18/929,129

(22) Filed: Oct. 28, 2024

(30) Foreign Application Priority Data
Aug. 26, 2024 (GR) 20240100593

(51) Int. Cl. G06T 7/73; G06T 7/62; G06T 17/00; G06V 10/60

(52) U.S. Cl. CPC G06T 7/73; G06T 7/62; G06T 17/00; G06V 10/60

(57) ABSTRACT

A method for hand tracking is described. In one aspect, a method includes accessing an image captured with a first camera of a device, the device includes a light source, detecting a location of the light source, a location of the first camera, a location of a hand depicted in the image, a location of a shadow of the hand depicted in the image, determining a scene geometry in the image, and determining a hand scale and a hand pose by applying a triangulation algorithm based on the scene geometry, the location of the light source, the location of the first camera, the location of the hand, and the location of the shadow of the hand.

### CLAIM OF PRIORITY

This application claims the benefit of priority to Greece Patent Application Serial No. 20240100593, filed on Aug. 26, 2024, which is incorporated herein by reference in its entirety.

### TECHNICAL FIELD

The subject matter disclosed herein generally relates to extended reality (XR). More specifically, but not exclusively, the subject matter relates to hand-scale estimation techniques that facilitate the rendering of virtual content in an XR environment.

### BACKGROUND

The traditional hand-tracking technologies often use methods such as stereo vision or depth sensors, both of which have significant drawbacks. Stereo vision requires the precise alignment and calibration of two cameras, leading to increased complexity and power consumption. This method is also prone to errors from camera misalignment and requires intensive computational resources to compute disparities between the camera feeds. On the other hand, depth sensors, while providing valuable spatial data, add extra hardware costs, increase power consumption, and often require a larger device form factor, which can be undesirable in consumer electronics. These conventional approaches also tend to be less effective in varying lighting conditions, limiting their practical usability in real-world applications.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a network environment for operating an AR display device in accordance with one example embodiment.

FIG. 2 is a block diagram illustrating an AR display device in accordance with one example embodiment.

FIG. 3 is a block diagram illustrating a tracking system in accordance with one example embodiment.

FIG. 4 is a block diagram illustrating a hand tracking system in accordance with one example embodiment.

FIG. 5 is a block diagram illustrating a process pipeline in accordance with one example embodiment.

FIG. 6 is a diagram illustrating a display device detecting a hand shadow on a surface in accordance with one example embodiment.

FIG. 7 is a diagram illustrating detecting a hand shadow on a surface in accordance with one example embodiment.

FIG. 8 is a flow diagram illustrating a method for shadow-guided hand scale and distance estimation for hand tracking in accordance with one example embodiment.

FIG. 9 illustrates a routine 900 in accordance with one embodiment.

FIG. 10 is block diagram showing a software architecture within which the present disclosure may be implemented, according to an example embodiment.

FIG. 11 is a diagrammatic representation of a machine in the form of a computer system within which a set of instructions may be executed for causing the machine to perform any one or more of the methodologies discussed herein, according to one example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Mixed reality (MR) or extended reality (XR) refers to a spectrum of immersive technologies that blend the physical and digital worlds, creating environments where real and virtual elements coexist and interact in real time. These technologies encompass augmented reality (AR), virtual reality (VR), and hybrid systems that combine aspects of both. In mixed-reality environments, users can interact with digital objects that are seamlessly integrated into their physical surroundings or experience fully immersive virtual worlds that respond to their movements and actions. This technology enables more natural and intuitive interactions with digital content, making it particularly valuable for applications in fields such as education, healthcare, engineering, and entertainment. Mixed reality systems often utilize advanced hand-tracking technologies, like the shadow-based method described in the invention, to allow users to manipulate virtual objects with their hands, enhancing the sense of immersion and enabling more precise control in digital environments.

Traditional hand-tracking systems often utilize stereo vision techniques, which require the simultaneous operation of two cameras. This approach necessitates precise alignment and calibration of the cameras to ensure accurate depth estimation and object tracking. However, the use of dual cameras not only complicates the hardware setup but also significantly increases the power consumption of the device. Moreover, stereo vision systems are highly sensitive to the quality of synchronization between the cameras and can be prone to errors due to misalignment, especially in portable devices where physical disturbances are common. Additionally, these systems typically require complex computational algorithms to manage and rectify the differences between the two camera feeds, further straining the device's processing capabilities and draining its battery life.

Moreover, traditional methods may use depth sensors to improve hand-tracking accuracy. While these sensors offer useful data, they also require additional hardware, leading to higher device costs and complexity. Additionally, depth sensors increase power consumption, which is a significant drawback for battery-operated mobile and wearable devices. Integrating these sensors often requires a larger device size, which can be a disadvantage in consumer electronics where compactness and aesthetics are crucial. Relying on depth sensors can also limit the hand-tracking technology's versatility in different lighting conditions or environments, impacting the user experience.

The present application explains how hand tracking can be achieved by using the shadows created by the hand on background surfaces to determine the hand's size and distance. This approach makes use of a fixed distance between an IR projector and a single IR camera, which reduces the hardware requirements by eliminating the need for dual cameras typically used in stereo vision systems. By identifying the shadows on recognized surfaces, such as floors or walls, the system can accurately calculate the hand's position and movements without the high power consumption associated with traditional methods. This technique is especially useful in controlled environments where the layout of the surrounding area is either known or can be easily figured out, allowing for precise and efficient hand tracking.

The presently described system also addresses common issues found in existing hand-tracking technologies, such as high sensitivity to hardware alignment and the need for highly accurate and compute-intensive online bending estimation. In turn, the system becomes reliant on a background surface model with associated errors. However, the sensitivity to this background surface error is low due to the geometrical setup. The well-known distance of the light emitter to the camera and the higher distance of the shadow (background surface) relative to the hand leads to an attenuation of any background surface error for the hand-pose estimation. The presently described approach not only enhances the practicality and applicability of hand tracking in everyday devices but also opens up new possibilities for its use in mobile and wearable technology. The method's robustness against typical environmental variations and its ability to function without an active illuminator when a known point-light source is available further underscore its versatility and innovative edge in the field of hand-tracking technology.

In one example embodiment, the present application describes a method for hand tracking. In one aspect, In one aspect, a method includes accessing an image captured with a first camera of a device, the device includes a light source, detecting a location of the light source, a location of the first camera, a location of a hand depicted in the image, a location of a shadow of the hand depicted in the image, determining a scene geometry in the image, and determining a hand scale and a hand pose by applying a triangulation algorithm based on the scene geometry, the location of the light source, the location of the first camera, the location of the hand, and the location of the shadow of the hand.

As a result, one or more of the methodologies described herein facilitate solving the technical problem of limited computation resources on a mobile device. The presently described method provides an improvement to the operation of the functioning of a computer by reducing power consumption related to hand-tracking using a camera of a mobile device. As such, one or more of the methodologies described herein may obviate a need for certain efforts or computing resources. Examples of such computing resources include processor cycles, network traffic, memory usage, data storage capacity, power consumption, network bandwidth, and cooling capacity.

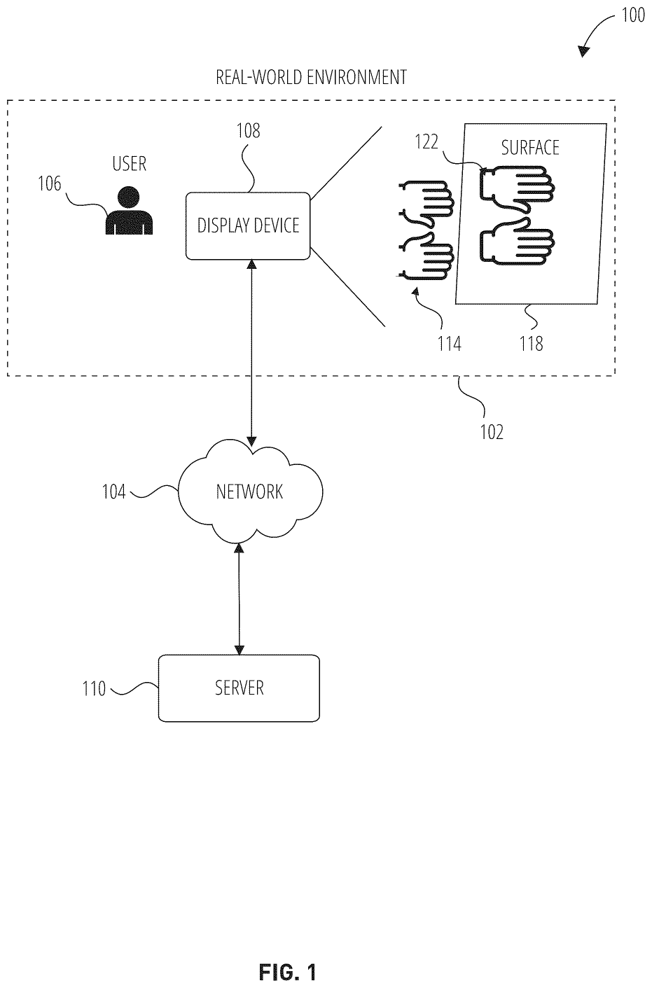

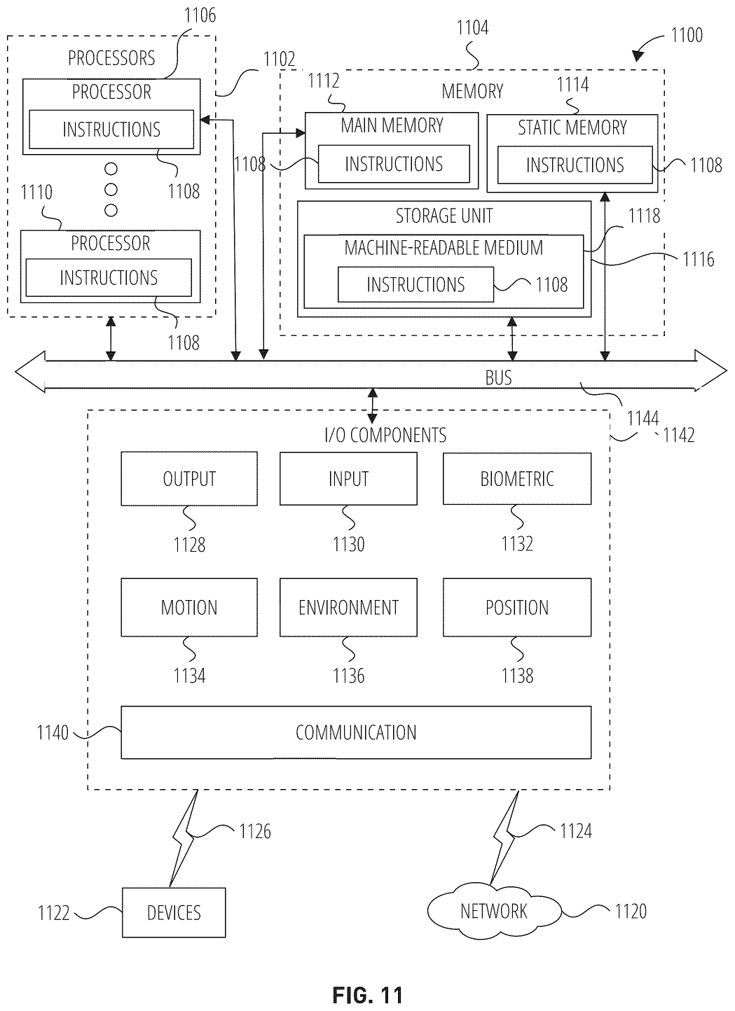

FIG. 1 is a network diagram illustrating a network environment 100 suitable for operating a display device 108, according to some example embodiments. The network environment 100 includes a display device 108 and a server 110, communicatively coupled to each other via a network 104. The display device 108 and the server 110 may each be implemented in a computer system, in whole or in part, as described below with respect to FIG. 11. The server 110 may be part of a network-based system. For example, the network-based system may be or include a cloud-based server system that provides additional information, such as virtual content (e.g., three-dimensional models of virtual objects) to the display device 108.

A user 106 operates the display device 108. The user 106 may be a human user (e.g., a human being), a machine user (e.g., a computer configured by a software program to interact with the display device 108), or any suitable combination thereof (e.g., a human assisted by a machine or a machine supervised by a human). The user 106 is not part of the network environment 100, but is associated with the display device 108.

The display device 108 can include a computing device with a display such as a smartphone, a tablet computer, or a wearable computing device (e.g., watch or glasses). The computing device may be hand-held or may be removably mounted to a head of the user 106. In one example, the display may be a screen that displays what is captured with a camera of the display device 108. In another example, the display of the display device 108 may be transparent (e.g., translucent) such as in lenses of wearable computing glasses. In another example embodiment, the display may be non-transparent and wearable by the user 106 to cover the field of vision of the user 106.

The display device 108 includes a tracking system (not shown). The tracking system tracks the pose (e.g., position and orientation) of the display device 108 relative to the real-world environment 102 using optical sensors (e.g., depth-enabled 3D camera, image camera), inertial sensors (e.g., gyroscope, accelerometer), wireless sensors (Bluetooth, Wi-Fi), GPS sensor, and audio sensor to determine the location of the display device 108 within the real-world environment 102. In another example embodiment, the tracking system tracks the pose of the hand 114 in video frames captured by the optical sensors. For example, the tracking system may only use one optical sensor (e.g., an infrared camera) to recognize the hand 114 and track a scale and pose of the hand 114. In one example, the display device 108 comprises an infrared emitter (not shown) that illuminates the hand 114. The hand 114 casts a hand shadow 122 on a surface 118 (e.g., a table, a floor, a wall, or detected geometry of the real-world environment 102).

The display device 108 includes a 3D reconstruction engine (not shown) configured to construct a 3D model of the hand 114. The display device 108 operates an application that uses data from the 3D model of the hand 114. For example, the application includes an AR (Augmented Reality) application configured to provide the user 106 with an experience triggered by the hand 114 or the surface 118. For example, the display device 108 tracks the hand 114/surface 118 and accesses virtual content associated with the hand 114 or surface 118. In one example, the AR application generates additional information corresponding to the 3D model of the hand 114 and presents this additional information in a display of the display device 108. If the 3D model is not recognized locally at the display device 108, the display device 108 downloads additional information (e.g., other 3D models) from a database of the server 110 over the network 104.

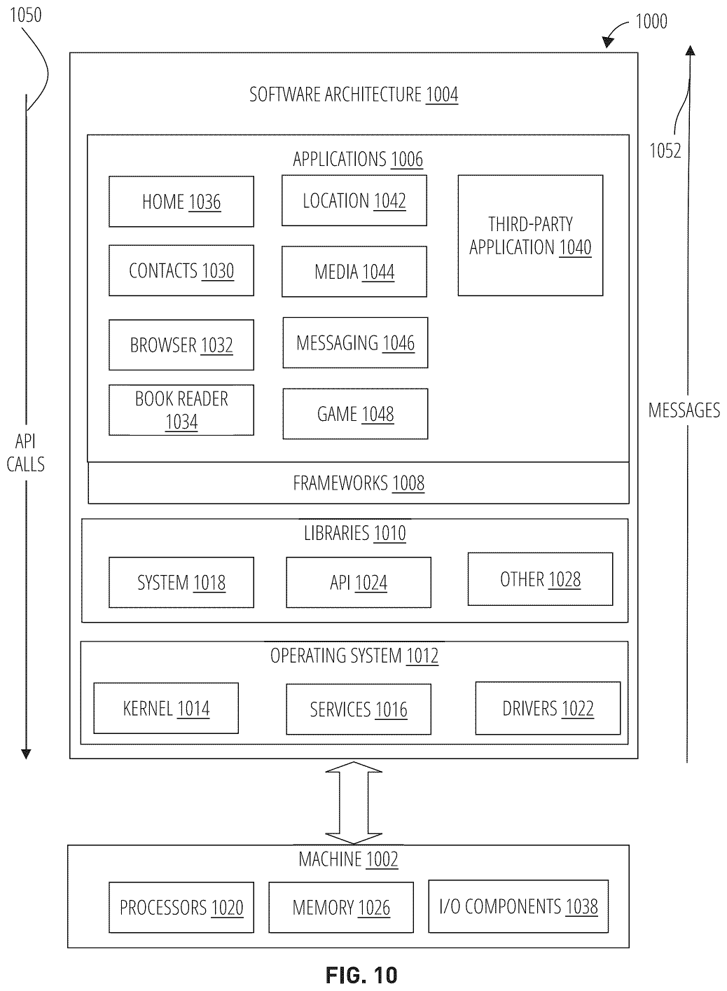

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10 to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 104 may be any network that enables communication between or among machines (e.g., server 110), databases, and devices (e.g., display device 108). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof.

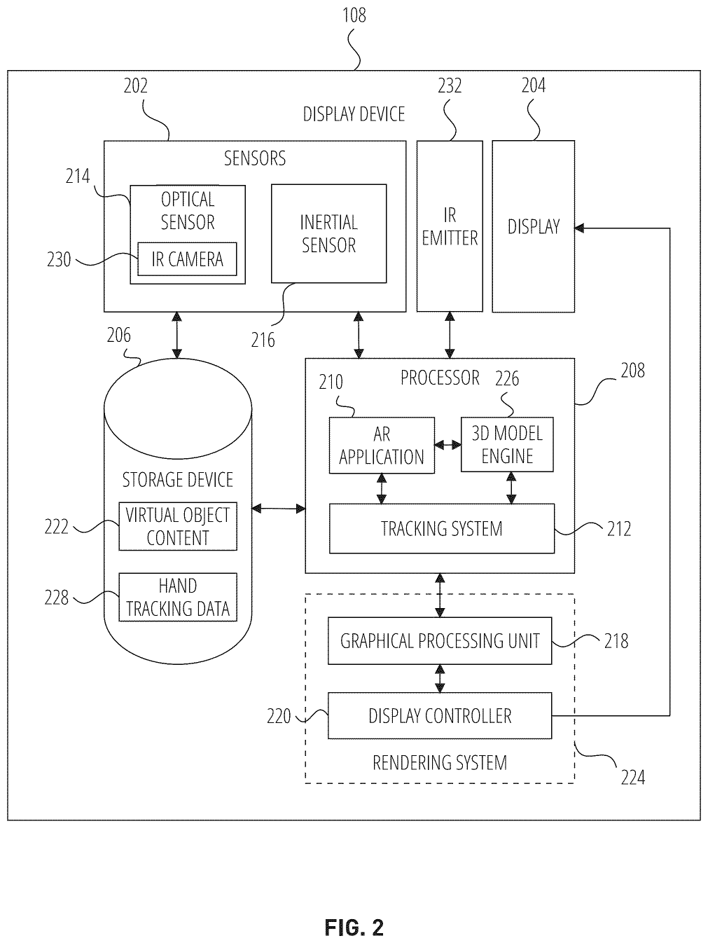

FIG. 2 is a block diagram illustrating modules (e.g., components) of the display device 108, according to some example embodiments. The display device 108 includes sensors 202, an IR emitter 232, a display 204, a processor 208, a rendering system 224, and a storage device 206. Examples of display device 108 include a head-mounted device, a wearable computing device, a desktop computer, a vehicle computer, a tablet computer, a navigational device, a portable media device, or a smart phone.

The sensors 202 include, for example, an optical sensor 214 (e.g., stereo cameras, camera such as a color camera, (infrared) IR camera 230, a depth sensor and one or multiple grayscale, global shutter tracking cameras) and an inertial sensor 216 (e.g., gyroscope, accelerometer). Other examples of sensors 202 include a proximity or location sensor (e.g., near field communication, GPS, Bluetooth, Wifi), an audio sensor (e.g., a microphone), or any suitable combination thereof. It is noted that the sensors 202 described herein are for illustration purposes and the sensors 202 are thus not limited to the ones described above.

The IR camera 230 is a device that emits light in the infrared spectrum, which is beyond the visible spectrum detectable by the human eye. Infrared light has longer wavelengths than visible light, typically ranging from about 700 nanometers to 1 millimeter. IR emitters are commonly used in various applications, including remote controls, data transmission, and sensing systems.

The display 204 includes a screen or monitor configured to display images generated by the processor 208. In one example embodiment, the display 204 may be transparent/translucent or semi-transparent so that the user 106 can see through the display 204 (in AR use case). In another example, the display 204, such as a LCOS display, presents each frame of virtual content in multiple presentations.

The processor 208 operates an AR application 210, a 3D model engine 226, and a tracking system 212. The tracking system 212 detects and tracks the hand 114 and the surface 112 using computer vision. The 3D model engine 226 constructs a 3D model of the hand 114/surface 112 and stores the hand tracking data 228 in the storage device 206. The AR application 210 retrieves virtual content based on the 3D model of the hand 114/surface 112. The AR rendering system 224 renders the virtual object in the display 204. In an AR scenario, the AR application 210 generates annotations/virtual content that are overlaid (e.g., superimposed upon, or otherwise displayed in tandem with, and appear anchored to) on an image of the surface 112 captured by the optical sensor 214. The annotations/virtual content may be manipulated by changing the pose of the surface 112 (e.g., its physical location, orientation, or both) relative to the optical sensor 214. Similarly, the visualization of the annotations/virtual content may be manipulated by adjusting the pose of the display device 108 relative to the surface 112.

The tracking system 212 estimates a pose of the display device 108 and a pose of the hand 114/surface 112. In one example, the tracking system 212 uses image data and corresponding inertial data from the optical sensor 214 and the inertial sensor 216 to track the location and pose of the display device 108 relative to a frame of reference (e.g., real-world environment 102). In one example, the tracking system 212 uses the sensor data to determine the three-dimensional pose of the display device 108. The three-dimensional pose is a determined orientation and position of the display device 108 in relation to the user's real-world environment 102. For example, the display device 108 may use images of the user's real-world environment 102, as well as other sensor data to identify a relative position and orientation of the display device 108 from physical objects in the real-world environment 102 surrounding the display device 108. The tracking system 212 continually gathers and uses updated sensor data describing movements of the display device 108 to determine updated three-dimensional poses of the display device 108 that indicate changes in the relative position and orientation of the display device 108 from the physical objects in the real-world environment 102. The tracking system 212 provides the three-dimensional pose of the display device 108 to the rendering system 224.

In another example, the tracking system 212 uses image data (hand shadow 122, hand 114) to track the location and pose of hand 114 relative to the frame of reference (e.g., real-world environment 102) or relative to the display device 108. The tracking system 212 described utilizes infrared (IR) light to accurately track both the location of hand 114 and its shadow (hand shadow 122), enabling precise interaction within digital environments. By employing IR emitter 232 and IR camera 230, the display device 108 projects IR light which is then cast as shadows by the user's hand movements. These shadows are detected by the IR camera 230, which captures the subtle variations in light intensity caused by the hand obstructing the IR light source. The system calculates the position and movement of the hand by analyzing these shadow patterns against known geometries and baselines established between the IR emitter 232 and the IR camera 230. This method not only enhances the accuracy of hand tracking in various lighting conditions but also simplifies the hardware requirements, as it primarily relies on the detection of shadows rather than requiring multiple cameras or complex sensor arrays.

The rendering system 224 includes a Graphical Processing Unit 218 and a display controller 220. The Graphical Processing Unit 218 includes a render engine (not shown) that is configured to render a frame of a 3D model of a virtual object based on the virtual content provided by the AR application 210 and the pose of the display device 108. In other words, the Graphical Processing Unit 218 uses the three-dimensional pose of the display device 108 to generate frames of virtual content to be presented on the display 204. For example, the Graphical Processing Unit 218 uses the three-dimensional pose to render a frame of the virtual content such that the virtual content is presented at an appropriate orientation and position in the display 204 to properly augment the user's reality. As an example, Graphical Processing Unit 218 may use the three-dimensional pose data to render a frame of virtual content such that, when presented on display 204, the virtual content appears anchored to surface 112 in the user's real-world environment 102. The Graphical Processing Unit 218 generates updated frames of virtual content based on updated three-dimensional poses of the display device 108, which reflect changes in the position and orientation of the user 106 in relation to the surface 112 in the user's real-world environment 102.

The Graphical Processing Unit 218 transfers the rendered frame to the display controller 220. The display controller 220 is positioned as an intermediary between the Graphical Processing Unit 218 and the display 204, receives the image data (e.g., annotated rendered frame) from the Graphical Processing Unit 218, and provides the annotated rendered frame to the display 204.

The storage device 206 stores virtual object content 222 and hand tracking data 228. The virtual object content 222 includes, for example, a database of visual references (e.g., images, QR codes) and corresponding virtual content (e.g., a three-dimensional model of virtual objects). The hand tracking data 228 is generated by the 3D model engine 226.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

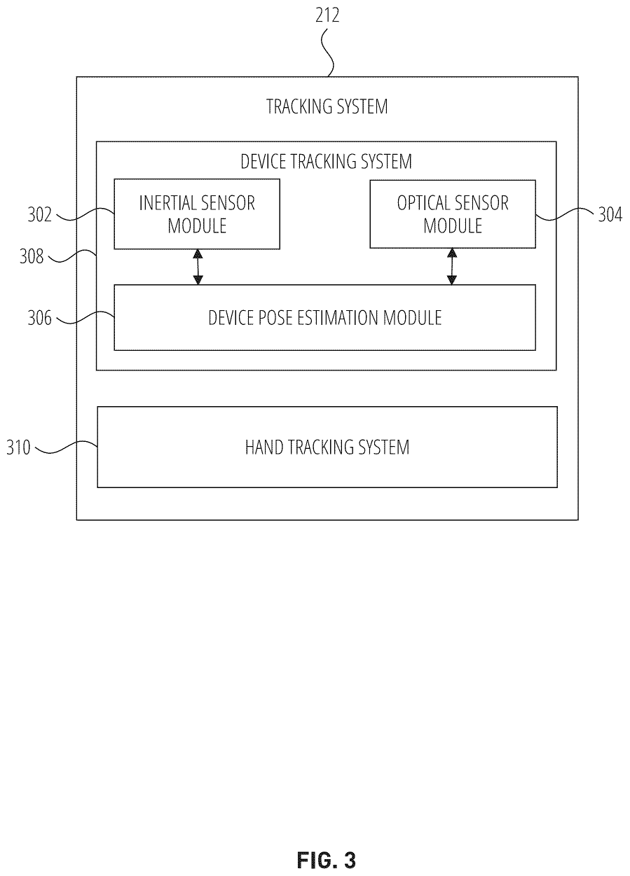

FIG. 3 illustrates the tracking system 212 in accordance with one example embodiment. The tracking system 212 includes, for example, a device tracking system 308 and a hand tracking system 310. The device tracking system 308 tracks a pose of the display device 108. The hand tracking system 310 tracks a pose of the hand 114.

The device tracking system 308 includes an inertial sensor module 302, an optical sensor module 304, and a device pose estimation module 306. The inertial sensor module 302 accesses inertial sensor data from the inertial sensor 216. The optical sensor module 304 accesses optical sensor data from the optical sensor 214.

The device pose estimation module 306 determines a pose (e.g., location, position, orientation) of the Display device 108 relative to a frame of reference (e.g., real-world environment 102). In one example embodiment, the device pose estimation module 306 estimates the pose of the Display device 108 based on 3D maps of feature points from images captured by the optical sensor 214 (via an optical sensor module 304) and from the inertial sensor data captured by the inertial sensor 216 (via inertial sensor module 302).

In one example, the device pose estimation module 306 includes an algorithm that combines inertial information from the inertial sensor 216 and image information from the optical sensor 214 that are coupled to a rigid platform (e.g., display device 108) or a rig. A rig may consist of multiple cameras (with non-overlapping (distributed aperture) or overlapping (stereo or more) fields-of-view) mounted on a rigid platform with an Inertial Measuring Unit, also referred to as IMU (e.g., rig may thus have at least one IMU and at least one camera).

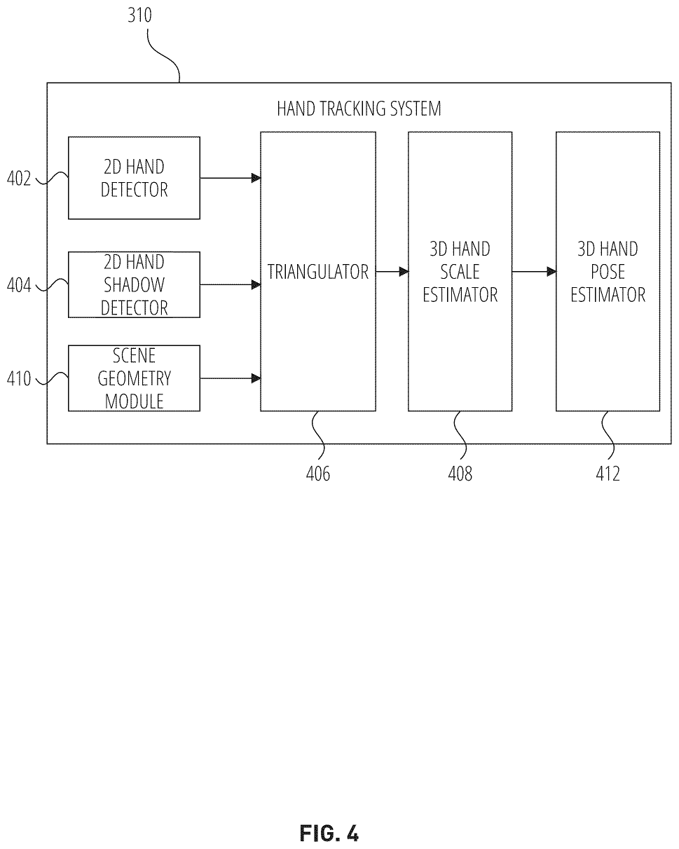

The hand tracking system 310 operates a computer vision algorithm (e.g., hand tracking algorithm) to detect and track the location of hand 114 depicted in a frame captured by the optical sensor 214. In one example, the hand tracking system 310 detects and identifies pixels corresponding to the hand 114 of the user 106 in an image captured with the IR camera 230. The hand tracking system 310 labels and segments pixels in the images belonging to the hand 114. Furthermore, the hand tracking system 310 detects and identifies pixels corresponding to the hand shadow 122 of the user 106 in the image captured with the IR camera 230. The hand tracking system 310 labels and segments pixels in the image belonging to the hand shadow 122. The hand tracking system 310 determines the pose of the hand 114 based on data from the detected location of the hand 114 and the hand shadow 122. The hand tracking system 310 is described in more detail below with respect to FIG. 4.

FIG. 4 is a block diagram illustrating the hand tracking system 310 designed to estimate the scale and pose of hand 114 in three dimensions using shadow detection (without having to use stereoscopic cameras). The hand tracking system 310 comprises a 2D hand detector 402, a 2D hand shadow detector 404, a triangulator 406, a 3D hand scale estimator 408, a scene geometry module 410, and a 3D hand pose estimator 412.

The 2D hand detector 402 is responsible for detecting the hand 114 within the two-dimensional image captured by the IR camera 230 (or any single camera operating at the display device 108). The 2D hand detector 402 utilizes image processing algorithms to identify the outline and key features of the hand 114.

The 2D hand shadow detector 404 operates in parallel with the 2D hand detector 402. The 2D hand shadow detector 404 detects the shadow (e.g., hand shadow 122) of the hand 114 cast by IR emitter 232 (e.g., IR light). The 2D hand shadow detector 404 analyzes variations in light intensity and contrast to determine the hand shadow 122 and position relative to the hand 114.

The triangulator 406 calculates the geometric properties of the scene, including distances and angles between the hand 114, the light source (e.g., IR emitter 232 or a predetermined location of known existing point-light such as the sun/moon), and the surface 112 onto which the shadow is cast. This information is used to accurately interpret the shadow data in relation to the actual hand 114. The triangulator 406 uses data from both the 2D hand detector 402 and the 2D hand shadow detector 404 to compute the three-dimensional coordinates of the hand 114. It applies principles of triangulation, using the known baseline between the IR emitter 232 and the IR camera 230, along with the angles derived from the shadow and hand positions.

In another example embodiment, the scene geometry module 410 operates by collecting data from the optical sensor 214 and possibly other sensors to construct a detailed geometric model of the scene (e.g., real-world environment 102). This includes identifying and characterizing surfaces where shadows may be cast, such as floors, walls, or any other visible planes. The scene geometry module 410 uses techniques such as plane detection, depth estimation, and possibly simultaneous localization and mapping (SLAM) to create a comprehensive understanding of the scene's layout.

The 3D hand scale estimator 408 estimates the scale of the hand 114 in the three-dimensional space. For example, the 3D hand scale estimator 408 adjusts the perceived size of the hand 114 based on the distance from the IR camera 230, ensuring that the hand's dimensions are represented accurately regardless of its position within the field of view.

The 3D hand pose estimator 412 determines the pose of the hand 114, including the orientation and articulation of fingers. This is achieved by analyzing the relative positions of key hand features identified in the 2D image and refined through 3D triangulation.

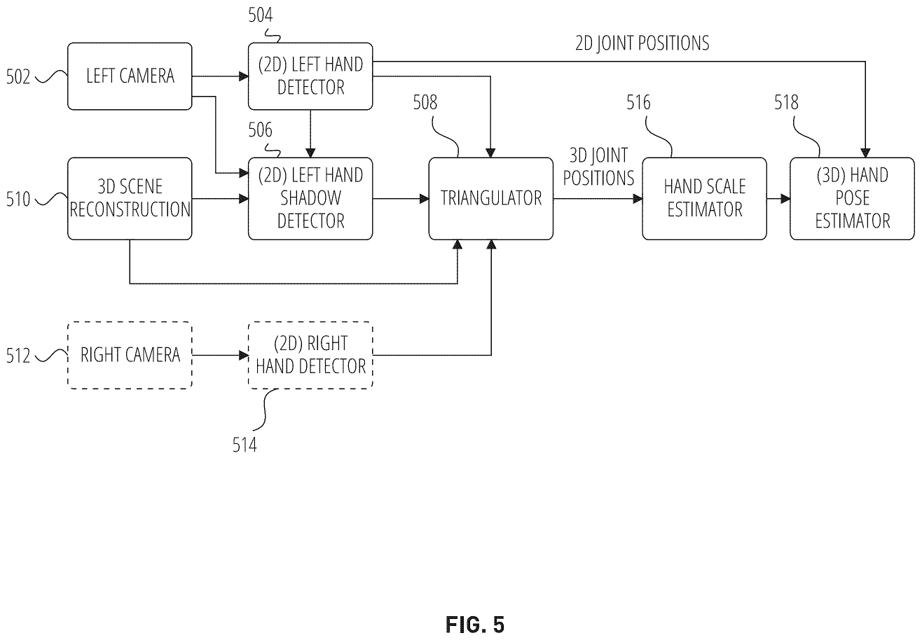

FIG. 5 is a block diagram illustrating a process pipeline of the hand tracking system 310 in accordance with one example embodiment. This hand tracking system 310 is designed to accurately determine a pose and scale of the hand 114, and the three-dimensional positions and movements of the hand 114 in various interactive applications. The hand tracking system 310 activates only one camera (e.g., left camera 502) without the right camera 512 or the (2D) right hand detector 514 being active.

The left camera 502 includes for example, the IR camera 230. The left camera 502 provides image data to the (2D) left hand detector 504 and the (2D) left hand shadow detector 506. The (2D) left hand detector 504 is responsible for detecting the hand 114 within the two-dimensional images captured by the left camera 502. The (2D) left hand detector 504 utilizes advanced image processing algorithms to identify the outline and key features of the hand 114, such as fingertips and joints, from the left camera 502's viewpoint.

The (2D) left hand shadow detector 506 operates on the image from the left camera 502 to detect the shadow of the hand 114 cast by ambient (e.g., the sun/moon) or directed light sources (e.g., IR emitter 232). The (2D) left hand shadow detector 506 analyzes variations in light intensity and contrast to accurately delineate the shadow's shape and position, providing data for enhancing the depth perception and 3D modeling of the hand 114.

The hand scale estimator 516 can utilize data from one or more cameras to reconstruct the three-dimensional scene. The reconstruction process involves applying computer vision techniques such as stereo matching and depth mapping to create a comprehensive 3D model of the scene.

The triangulator 508 uses the data obtained from the (2D) left hand detector 504, (2D) left hand shadow detector 506, and 3D scene reconstruction 510 to calculate the precise three-dimensional coordinates of the hand 114. It employs principles of triangulation, leveraging the known distances and angles between the cameras and the hand 114, as well as between the hand 114 and its hand shadow 122, to determine the hand's exact location in space. The triangulator 508 provides the 3D joint positions to the hand scale estimator 516.

The hand scale estimator 516 estimates the scale of the hand 114 in the three-dimensional space based on the 3D joint positions data. The (3D) hand pose estimator 518 determines the pose of the hand 114, including the orientation and articulation of fingers. For example, the (3D) hand pose estimator 518 analyzes the relative positions of key hand features identified in the 2D images and refined through 3D triangulation to accurately model the hand's pose.

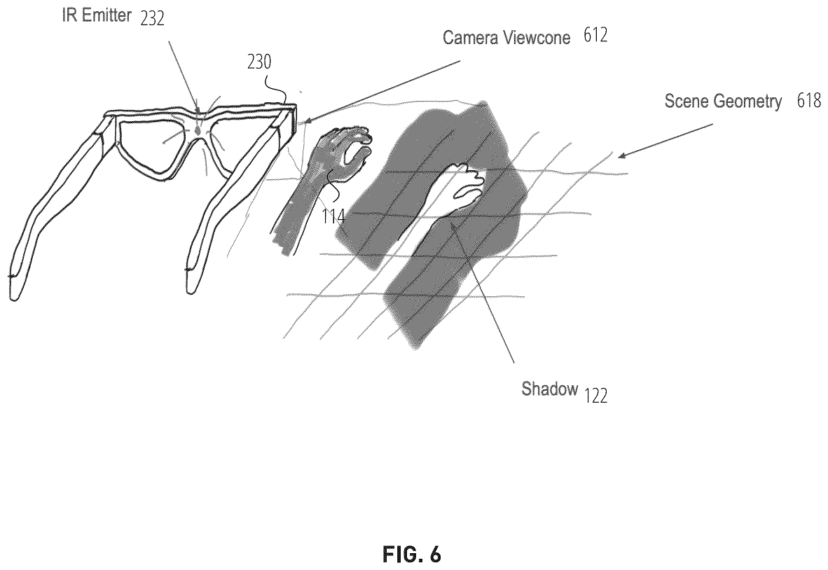

FIG. 6 is a diagram illustrating the display device 108 detecting a hand shadow on a surface in accordance with one example embodiment. The IR emitter 232 emits an IR light on the hand 114 that casts a hand shadow 122 on the scene geometry 618 (e.g., surface 112). The IR camera 230 picks up the image data from its camera viewcone 612.

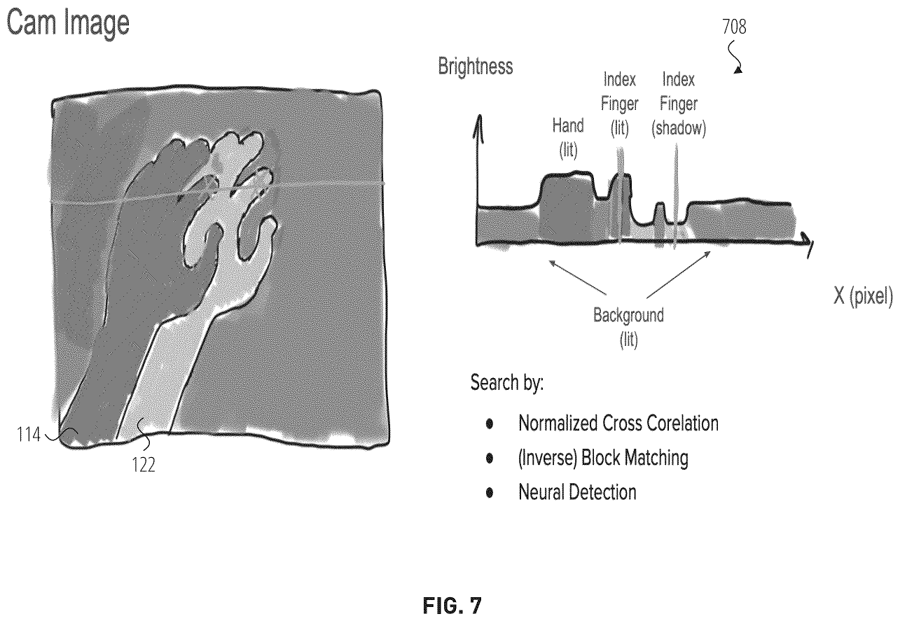

FIG. 7 is a diagram illustrating detecting a hand shadow on a surface in accordance with one example embodiment. The hand tracking system 310 detects the hand shadow 122 by identifying brightness along a brightness profile 708.

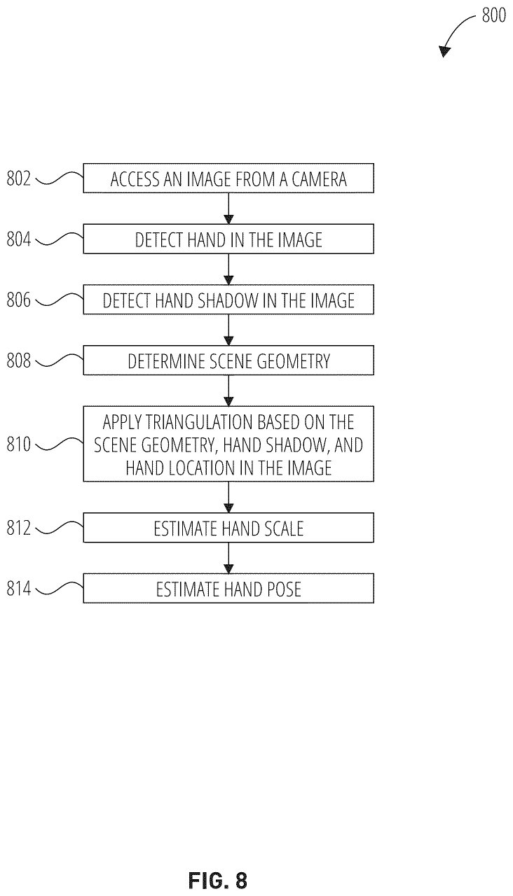

FIG. 8 is a flow diagram illustrating a method for shadow-guided hand scale and distance estimation for hand tracking in accordance with one example embodiment. Operations in the routine 800 may be performed by the tracking system 212, using components (e.g., modules, engines) described above with respect to FIG. 2, FIG. 3, and FIG. 4. Accordingly, the routine 800 is described by way of example with reference to the tracking system 212 and hand tracking system 310. However, it shall be appreciated that at least some of the operations of the routine 800 may be deployed on various other hardware configurations or be performed by similar components residing elsewhere.

At block 802, the hand tracking system 310 accesses an image from a camera (e.g., IR camera 230). The image contains visual information of the hand 114 and its surrounding environment, serving as the primary data input for subsequent analysis.

At block 804, the hand tracking system 310 detects the hand 114 in the image. Advanced image processing algorithms analyze the image to identify the outline and key features of the hand 114, distinguishing it from other elements in the scene.

At block 806, the hand tracking system 310 detects hand shadow 122 in the image. This involves analyzing variations in light intensity and contrast to accurately delineate the shadow's shape and position relative to the hand 114.

At block 808, hand tracking system 310 calculates the geometric properties of the scene, including the distances and angles between the hand, the light source, and the surface onto which the shadow is cast. This geometric analysis is essential for accurate depth perception and spatial orientation of the hand.

At block 810, hand tracking system 310, utilizing the data obtained from the hand 114 and shadow detection, along with the scene geometry, applies triangulation techniques to compute the three-dimensional coordinates of the hand 114. This step integrates the spatial information to create a precise 3D model of the hand's position and orientation.

At block 812, hand tracking system 310 estimates the scale of the hand 114 based on its calculated distance from the IR camera 230. The system adjusts the perceived size of the hand 114 to ensure that its dimensions are accurately represented.

At block 814, hand tracking system 310 estimates the hand pose, and determining the orientation and articulation of the hand 114 and fingers. The hand tracking system 310 analyzes the relative positions of key hand features, refined through the triangulation process, to accurately model the hand's pose. By integrating shadow detection with detailed scene geometry analysis, the hand tracking system 310 ensures high accuracy and robustness in hand tracking, making it suitable for advanced applications in augmented reality, virtual reality, and interactive systems where precise and real-time hand interaction is essential.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

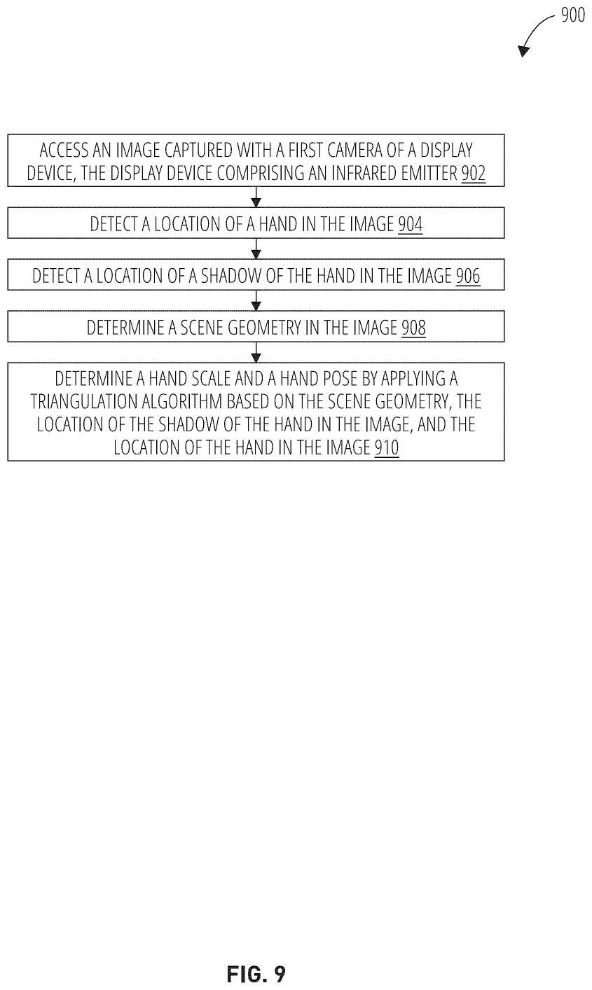

FIG. 9 illustrates a routine 900 in accordance with one embodiment.

In block 902, routine 900 accesses an image captured with a first camera of a display device, the display device comprising an infrared emitter. In block 904, routine 900 detects a location of a hand in the image. In block 906, routine 900 detects a location of a shadow of the hand in the image. In block 908, routine 900 determines a scene geometry in the image. In block 910, routine 900 determines a hand scale and a hand pose by applying a triangulation algorithm based on the scene geometry, the location of the shadow of the hand in the image, and the location of the hand in the image.

FIG. 10 is a block diagram 1000 illustrating a software architecture 1004, which can be installed on any one or more of the devices described herein. The software architecture 1004 is supported by hardware such as a machine 1002 that includes Processors 1020, memory 1026, and I/O Components 1038. In this example, the software architecture 1004 can be conceptualized as a stack of layers, where each layer provides a particular functionality. The software architecture 1004 includes layers such as an operating system 1012, libraries 1010, frameworks 1008, and applications 1006. Operationally, the applications 1006 invoke API calls 1050 through the software stack and receive messages 1052 in response to the API calls 1050.

The operating system 1012 manages hardware resources and provides common services. The operating system 1012 includes, for example, a kernel 1014, services 1016, and drivers 1022. The kernel 1014 acts as an abstraction layer between the hardware and the other software layers. For example, the kernel 1014 provides memory management, Processor management (e.g., scheduling), Component management, networking, and security settings, among other functionality. The services 1016 can provide other common services for the other software layers. The drivers 1022 are responsible for controlling or interfacing with the underlying hardware. For instance, the drivers 1022 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1010 provide a low-level common infrastructure used by the applications 1006. The libraries 1010 can include system libraries 1018 (e.g., C standard library) that provide functions such as memory allocation functions, string manipulation functions, mathematic functions, and the like. In addition, the libraries 1010 can include API libraries 1024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1010 can also include a wide variety of other libraries 1028 to provide many other APIs to the applications 1006.

The frameworks 1008 provide a high-level common infrastructure that is used by the applications 1006. For example, the frameworks 1008 provide various graphical user interface (GUI) functions, high-level resource management, and high-level location services. The frameworks 1008 can provide a broad spectrum of other APIs that can be used by the applications 1006, some of which may be specific to a particular operating system or platform.

In an example embodiment, the applications 1006 may include a home application 1036, a contacts application 1030, a browser application 1032, a book reader application 1034, a location application 1042, a media application 1044, a messaging application 1046, a game application 1048, and a broad assortment of other applications such as a third-party application 1040. The applications 1006 are programs that execute functions defined in the programs. Various programming languages can be employed to create one or more of the applications 1006, structured in a variety of manners, such as object-oriented programming languages (e.g., Objective-C, Java, or C++) or procedural programming languages (e.g., C or assembly language). In a specific example, the third-party application 1040 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or Linux OS, or other mobile operating systems. In this example, the third-party application 1040 can invoke the API calls 1050 provided by the operating system 1012 to facilitate functionality described herein.

FIG. 11 is a diagrammatic representation of the machine 1100 within which instructions 1108 (e.g., software, a program, an application, an applet, an app, or other executable code) for causing the machine 1100 to perform any one or more of the methodologies discussed herein may be executed. For example, the instructions 1108 may cause the machine 1100 to execute any one or more of the methods described herein. The instructions 1108 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1108, sequentially or otherwise, that specify actions to be taken by the machine 1100. Further, while only a single machine 1100 is illustrated, the term “machine” shall also be taken to include a collection of machines that individually or jointly execute the instructions 1108 to perform any one or more of the methodologies discussed herein.

The machine 1100 may include Processors 1102, memory 1104, and I/O Components 1142, which may be configured to communicate with each other via a bus 1144. In an example embodiment, the Processors 1102 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1106 and a Processor 1110 that execute the instructions 1108. The term “Processor” is intended to include multi-core Processors that may comprise two or more independent Processors (sometimes referred to as “cores”) that may execute instructions contemporaneously. Although FIG. 11 shows multiple Processors 1102, the machine 1100 may include a single Processor with a single core, a single Processor with multiple cores (e.g., a multi-core Processor), multiple Processors with a single core, multiple Processors with multiples cores, or any combination thereof.

The memory 1104 includes a main memory 1112, a static memory 1114, and a storage unit 1116, both accessible to the Processors 1102 via the bus 1144. The main memory 1104, the static memory 1114, and storage unit 1116 store the instructions 1108 embodying any one or more of the methodologies or functions described herein. The instructions 1108 may also reside, completely or partially, within the main memory 1112, within the static memory 1114, within machine-readable medium 1118 within the storage unit 1116, within at least one of the Processors 1102 (e.g., within the Processor's cache memory), or any suitable combination thereof, during execution thereof by the machine 1100.

The I/O Components 1142 may include a wide variety of Components to receive input, provide output, produce output, transmit information, exchange information, capture measurements, and so on. The specific I/O Components 1142 that are included in a particular machine will depend on the type of machine. For example, portable machines such as mobile phones may include a touch input device or other such input mechanisms, while a headless server machine will likely not include such a touch input device. It will be appreciated that the I/O Components 1142 may include many other Components that are not shown in FIG. 11. In various example embodiments, the I/O Components 1142 may include output Components 1128 and input Components 1130. The output Components 1128 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1130 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1142 may include biometric Components 1132, motion Components 1134, environmental Components 1136, or position Components 1138, among a wide array of other Components. For example, the biometric Components 1132 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1134 include acceleration sensor Components (e.g., accelerometer), gravitation sensor Components, rotation sensor Components (e.g., gyroscope), and so forth. The environmental Components 1136 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1138 include location sensor Components (e.g., a GPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The I/O Components 1142 further include communication Components 1140 operable to couple the machine 1100 to a network 1120 or devices 1122 via a coupling 1124 and a coupling 1126, respectively. For example, the communication Components 1140 may include a network interface Component or another suitable device to interface with the network 1120. In further examples, the communication Components 1140 may include wired communication Components, wireless communication Components, cellular communication Components, Near Field Communication (NFC) Components, Bluetooth® Components (e.g., Bluetooth® Low Energy), Wi-Fi® Components, and other communication Components to provide communication via other modalities. The devices 1122 may be another machine or any of a wide variety of peripheral devices (e.g., a peripheral device coupled via a USB).

Moreover, the communication Components 1140 may detect identifiers or include Components operable to detect identifiers. For example, the communication Components 1140 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication Components 1140, such as location via Internet Protocol (IP) geolocation, location via Wi-Fi® signal triangulation, location via detecting an NFC beacon signal that may indicate a particular location, and so forth.

The various memories (e.g., memory 1104, main memory 1112, static memory 1114, and/or memory of the Processors 1102) and/or storage unit 1116 may store one or more sets of instructions and data structures (e.g., software) embodying or used by any one or more of the methodologies or functions described herein. These instructions (e.g., the instructions 1108), when executed by Processors 1102, cause various operations to implement the disclosed embodiments.

The instructions 1108 may be transmitted or received over the network 1120, using a transmission medium, via a network interface device (e.g., a network interface Component included in the communication Components 1140) and using any one of a number of well-known transfer protocols (e.g., hypertext transfer protocol (HTTP)). Similarly, the instructions 1108 may be transmitted or received using a transmission medium via the coupling 1126 (e.g., a peer-to-peer coupling) to the devices 1122.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### EXAMPLES

Example 1 is a method comprising: accessing an image captured with a first camera of a device, the device comprising a light source; detecting a location of the light source, a location of the first camera, a location of a hand depicted in the image, a location of a shadow of the hand depicted in the image; determining a scene geometry in the image; and determining a hand scale and a hand pose by applying a triangulation algorithm based on the scene geometry, the location of the light source, the location of the first camera, the location of the hand, and the location of the shadow of the hand.

In Example 2, the subject matter of Example 1 includes, identifying a two-dimensional image of the hand in the image; identifying a two-dimensional image of the shadow of the hand in the image; and identifying three-dimensional joint positions of the hand based on the triangulation algorithm, wherein the hand pose identifies a three-dimensional hand pose.

In Example 3, the subject matter of Examples 1-2 includes, wherein the light source comprises one of a human-eye visible light or non-human-eye visible light.

In Example 4, the subject matter of Examples 1-3 includes, wherein determining the scene geometry comprises one of: modeling a physical environment of the device as a dense reconstruction, detecting planes as shadow surfaces in the physical environment of the device, or modeling the physical environment of the device based on semantic and object-based scene understanding.

In Example 5, the subject matter of Examples 1-4 includes, wherein detecting the location of the shadow of the hand comprises one of: detecting a pattern in a stripe pixel of the image, applying a normalized cross correlation between the hand and potential shadows searches along an epipolar line, or applying a hand shadow detection network.

In Example 6, the subject matter of Examples 1-5 includes, refining the scene geometry based on the location of the shadow of the hand, and a known hand-scale factor.

In Example 7, the subject matter of Examples 1-6 includes, identifying a known location of an external point-light, wherein determining the hand scale and the hand pose is based on applying the triangulation algorithm based on the known location of the external point-light, wherein detecting the location of the shadow of the hand in the image is based on determining the scene geometry in the image.

In Example 8, the subject matter of Examples 1-7 includes, wherein the device comprises a first camera and a second camera, wherein the first camera comprises an infrared camera, wherein the light source comprises an infrared light, wherein the method further comprises: disabling a second camera of the device, wherein detecting the location of the hand and the location of the shadow of the hand in the image is based only on the first camera of the device.

In Example 9, the subject matter of Examples 1-8 includes, accessing a first image captured with the first camera; detecting a first location of the light source, a first location of the first camera, a first location of the hand depicted in the first image, a first location of the shadow of the hand depicted in the first image; determining a first scene geometry in the first image; accessing a second image captured with the first camera; detecting a second location of the light source, a second location of the first camera, a second location of the hand depicted in the first image, a second location of the shadow of the hand depicted in the second image; determining a second scene geometry in the second image; and improving a detection of the hand based on the first scene geometry, the first location of the light source, the first location of the first camera, the first location of the hand, the location of the shadow of the hand, the second location of the light source, the second location of the first camera, the second location of the hand depicted in the first image, and the second location of the shadow of the hand depicted in the second image.

In Example 10, the subject matter of Examples 1-9 includes, wherein detecting the location of the shadow of the hand in the image is based on determining the scene geometry in the image, wherein detecting the location of the hand depicted in the image comprises: validating the location of the hand against the scene geometry in the image by rejecting shadows being mis-detected as real hands.

Example 11 is a device comprising: a first camera; a light source; a processor; and a memory storing instructions that, when executed by the processor, configure the device to: access an image captured with the first camera; detect a location of the light source, a location of the first camera, a location of a hand depicted in the image, a location of a shadow of the hand depicted in the image; determine a scene geometry in the image; and determine a hand scale and a hand pose by applying a triangulation algorithm based on the scene geometry, the location of the light source, the location of the first camera, the location of the hand, and the location of the shadow of the hand.

In Example 12, the subject matter of Example 11 includes, wherein the instructions further configure the device to: identify a two-dimensional image of the hand in the image; identify a two-dimensional image of the shadow of the hand in the image; and identify three-dimensional joint positions of the hand based on the triangulation algorithm, wherein the hand pose identifies a three-dimensional hand pose.

In Example 13, the subject matter of Examples 11-12 includes, wherein the light source comprises one of a human-eye visible light or non-human-eye visible light.

In Example 14, the subject matter of Examples 11-13 includes, wherein determining the scene geometry comprises one of: modeling a physical environment of the device as a dense reconstruction, detect planes as shadow surfaces in the physical environment of the device, or modeling the physical environment of the device based on semantic and object-based scene understanding.

In Example 15, the subject matter of Examples 11-14 includes, wherein detecting the location of the shadow of the hand comprises one of: detecting a pattern in a stripe pixel of the image, apply a normalized cross correlation between the hand and potential shadows searches along an epipolar line, or applying a hand shadow detection network.

In Example 16, the subject matter of Examples 11-15 includes, wherein the instructions further configure the device to: refine the scene geometry based on the location of the shadow of the hand, and a known hand-scale factor.

In Example 17, the subject matter of Examples 11-16 includes, wherein the instructions further configure the device to: identify a known location of an external point-light, wherein determining the hand scale and the hand pose is based on applying the triangulation algorithm based on the known location of the external point-light, wherein detecting the location of the shadow of the hand in the image is based on determining the scene geometry in the image.

In Example 18, the subject matter of Examples 11-17 includes, wherein the device comprises a first camera and a second camera, wherein the first camera comprises an infrared camera, wherein the light source comprises an infrared light, wherein the device is further configured to: disable a second camera of the device, wherein detecting the location of the hand and the location of the shadow of the hand in the image is based only on the first camera of the device.

In Example 19, the subject matter of Examples 11-18 includes, wherein the instructions further configure the device to: access a first image captured with the first camera; detect a first location of the light source, a first location of the first camera, a first location of the hand depicted in the first image, a first location of the shadow of the hand depicted in the first image; determine a first scene geometry in the first image; access a second image captured with the first camera; detect a second location of the light source, a second location of the first camera, a second location of the hand depicted in the first image, a second location of the shadow of the hand depicted in the second image; determine a second scene geometry in the second image; and improve a detection of the hand based on the first scene geometry, the first location of the light source, the first location of the first camera, the first location of the hand, the location of the shadow of the hand, the second location of the light source, the second location of the first camera, the second location of the hand depicted in the first image, and the second location of the shadow of the hand depicted in the second image.

Example 20 is a non-transitory computer-readable storage medium, the computer-readable storage medium including instructions that when executed by a computer, cause the computer to: access an image captured with a first camera of a device, the device comprising a light source; detect a location of the light source, a location of the first camera, a location of a hand depicted in the image, a location of a shadow of the hand depicted in the image; determine a scene geometry in the image; and determine a hand scale and a hand pose by applying a triangulation algorithm based on the scene geometry, the location of the light source, the location of the first camera, the location of the hand, and the location of the shadow of the hand.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method comprising:
accessing an image captured with a first camera of a device, the device comprising a light source;
detecting a location of the light source, a location of the first camera, a location of a hand depicted in the image, a location of a shadow of the hand depicted in the image;
determining a scene geometry in the image; and
determining a hand scale and a hand pose by applying a triangulation algorithm based on the scene geometry, the location of the light source, the location of the first camera, the location of the hand, and the location of the shadow of the hand.

2. The method of claim 1, further comprising:
identifying a two-dimensional image of the hand in the image;
identifying a two-dimensional image of the shadow of the hand in the image; and
identifying three-dimensional joint positions of the hand based on the triangulation algorithm,
wherein the hand pose identifies a three-dimensional hand pose.

3. The method of claim 1, wherein the light source comprises one of a human-eye visible light or non-human-eye visible light.

4. The method of claim 1, wherein determining the scene geometry comprises one of: modeling a physical environment of the device as a dense reconstruction, detecting planes as shadow surfaces in the physical environment of the device, or modeling the physical environment of the device based on semantic and object-based scene understanding.

5. The method of claim 1, wherein detecting the location of the shadow of the hand comprises one of: detecting a pattern in a stripe pixel of the image, applying a normalized cross correlation between the hand and potential shadows searches along an epipolar line, or applying a hand shadow detection network.

6. The method of claim 1, further comprising:
refining the scene geometry based on the location of the shadow of the hand, and a known hand-scale factor.

7. The method of claim 1, further comprising:
identifying a known location of an external point-light,
wherein determining the hand scale and the hand pose is based on applying the triangulation algorithm based on the known location of the external point-light,
wherein detecting the location of the shadow of the hand in the image is based on determining the scene geometry in the image.

8. The method of claim 1, wherein the device comprises a first camera and a second camera, wherein the first camera comprises an infrared camera, wherein the light source comprises an infrared light,
wherein the method further comprises:
disabling a second camera of the device,
wherein detecting the location of the hand and the location of the shadow of the hand in the image is based only on the first camera of the device.

9. The method of claim 1, further comprising:
accessing a first image captured with the first camera;
detecting a first location of the light source, a first location of the first camera, a first location of the hand depicted in the first image, a first location of the shadow of the hand depicted in the first image;
determining a first scene geometry in the first image;
accessing a second image captured with the first camera;
detecting a second location of the light source, a second location of the first camera, a second location of the hand depicted in the first image, a second location of the shadow of the hand depicted in the second image;
determining a second scene geometry in the second image; and
improving a detection of the hand based on the first scene geometry, the first location of the light source, the first location of the first camera, the first location of the hand, the location of the shadow of the hand, the second location of the light source, the second location of the first camera, the second location of the hand depicted in the first image, and the second location of the shadow of the hand depicted in the second image.

10. The method of claim 1, wherein detecting the location of the shadow of the hand in the image is based on determining the scene geometry in the image,
wherein detecting the location of the hand depicted in the image comprises: validating the location of the hand against the scene geometry in the image by rejecting shadows being mis-detected as real hands.

11. A device comprising:
a first camera;
a light source;
a processor; and
a memory storing instructions that, when executed by the processor, configure the device to:
access an image captured with the first camera;
detect a location of the light source, a location of the first camera, a location of a hand depicted in the image, a location of a shadow of the hand depicted in the image;
determine a scene geometry in the image; and
determine a hand scale and a hand pose by applying a triangulation algorithm based on the scene geometry, the location of the light source, the location of the first camera, the location of the hand, and the location of the shadow of the hand.

12. The device of claim 11, wherein the instructions further configure the device to:
identify a two-dimensional image of the hand in the image;
identify a two-dimensional image of the shadow of the hand in the image; and
identify three-dimensional joint positions of the hand based on the triangulation algorithm,
wherein the hand pose identifies a three-dimensional hand pose.

13. The device of claim 11, wherein the light source comprises one of a human-eye visible light or non-human-eye visible light.

14. The device of claim 11, wherein determining the scene geometry comprises one of: modeling a physical environment of the device as a dense reconstruction, detect planes as shadow surfaces in the physical environment of the device, or modeling the physical environment of the device based on semantic and object-based scene understanding.

15. The device of claim 11, wherein detecting the location of the shadow of the hand comprises one of: detecting a pattern in a stripe pixel of the image, apply a normalized cross correlation between the hand and potential shadows searches along an epipolar line, or applying a hand shadow detection network.

16. The device of claim 11, wherein the instructions further configure the device to:
refine the scene geometry based on the location of the shadow of the hand, and a known hand-scale factor.

17. The device of claim 11, wherein the instructions further configure the device to:
identify a known location of an external point-light,
wherein determining the hand scale and the hand pose is based on applying the triangulation algorithm based on the known location of the external point-light,
wherein detecting the location of the shadow of the hand in the image is based on determining the scene geometry in the image.

18. The device of claim 11, wherein the device comprises a first camera and a second camera, wherein the first camera comprises an infrared camera, wherein the light source comprises an infrared light,
wherein the device is further configured to:
disable a second camera of the device,
wherein detecting the location of the hand and the location of the shadow of the hand in the image is based only on the first camera of the device.

19. The device of claim 11, wherein the instructions further configure the device to:
access a first image captured with the first camera;
detect a first location of the light source, a first location of the first camera, a first location of the hand depicted in the first image, a first location of the shadow of the hand depicted in the first image;
determine a first scene geometry in the first image;
access a second image captured with the first camera;
detect a second location of the light source, a second location of the first camera, a second location of the hand depicted in the first image, a second location of the shadow of the hand depicted in the second image;
determine a second scene geometry in the second image; and
improve a detection of the hand based on the first scene geometry, the first location of the light source, the first location of the first camera, the first location of the hand, the location of the shadow of the hand, the second location of the light source, the second location of the first camera, the second location of the hand depicted in the first image, and the second location of the shadow of the hand depicted in the second image.

20. A non-transitory computer-readable storage medium, the computer-readable storage medium including instructions that when executed by a computer, cause the computer to:
access an image captured with a first camera of a device, the device comprising a light source;
detect a location of the light source, a location of the first camera, a location of a hand depicted in the image, a location of a shadow of the hand depicted in the image;
determine a scene geometry in the image; and
determine a hand scale and a hand pose by applying a triangulation algorithm based on the scene geometry, the location of the light source, the location of the first camera, the location of the hand, and the location of the shadow of the hand.
